(19) United States
(12) Patent Application Publication
(10) Pub. No.: US 2010/0325233 A1
(43) Pub. Date: Dec. 23, 2010

(54) DISPLAY DEVICE

(76) Inventors: Yoshihiro Sasaki, Tottori (JP); Tomoki Ueyama, Tottori (JP); Atsuto Matsushima, Tottori (JP); Naohiko Matsudaira, Tottori (JP); Kazuhiro Watanabe, Tottori (JP); Mitsuhisa Kawaguchi, Tottori (JP); Yoshinori Kishimoto, Tottori (JP); Masahiko Kinoshita, Tottori (JP)

Correspondence Address: MCDERMOTT WILL & EMERY LLP, 600 13TH STREET, N.W., WASHINGTON, DC, 20005-3096, US

(21) Appl. No.: 12/918,420

(22) PCT Filed: Feb. 13, 2009
(86) PCT No.: PCT/JP2009/052380

§ 371 Date: Aug. 19, 2010

(30) Foreign Application Priority Data
Feb. 19, 2008 (JP) 2008-037340
Feb. 20, 2008 (JP) 2008-038097
Oct. 3, 2008 (JP) 2008-258636
Oct. 3, 2008 (JP) 2008-258637

(51) Int. Cl. G06F 15/16

(52) U.S. Cl. 709/206

(57) ABSTRACT

A display device includes a condition judgment unit which judges whether a received email satisfies a predetermined condition. Moreover, the display device includes a data deletion unit which deletes attached data in an email from a recording unit if the condition judgment unit detects that the email does not satisfy the predetermined condition. Moreover, the display device includes a condition registration unit which receives a condition for storing attached data. The condition registration unit receives a transmission source email address of an email which a user desires to store. When an email is received by the email reception unit, the condition judgment unit judges whether the transmission source email address coincides with a part or whole of the reception-enabled address. If yes, the attached data is stored. Otherwise, the data is deleted.

### TECHNICAL FIELD

The present invention relates to a display device used as an electronic photo viewer (hereinafter, called an “electronic photo frame”) that displays digital image data, and more particularly, to a display device that is connected with a communication network and is capable of performing communication.

### BACKGROUND ART

In recent years, a flat-screen display device using a liquid crystal panel or the like is widespread. Because the flat-screen display device has a light weight and needs a small installation space, the flat-screen display device has an advantage that a user can suitably change the installation place and the installation angle.

As one of the above flat-screen display devices, an electronic photo frame is in practical use. The electronic photo frame is a display device that has the purpose of allowing an image taken with an imaging device such as a digital camera or the like to be easily enjoyed like a conventional silver halide photo. The electronic photo frame is able to receive image data via an outside recording medium such as a SD (Secure Digital) memory card or the like, for example, or via a network such as a LAN (Local Area Network) or the like and display the image data.

A patent document 1 regarding the above description discloses an electronic photo frame that is able to easily request a user on an image sending side for an image in a case where the user of the electronic photo frame wants to obtain a new image via a communication network.

Besides, a patent document 2 regarding the above description discloses an electronic photo frame that is an electronic photo frame used on a stand-alone basis, includes a means which reads data from a recording medium, and is able to expand and display image data which a user takes with a digital camera or the like and accumulates them into the recording medium.

Patent document 1: JP-A-2002-278864
Patent document 2: JP-A-1997-308558

### DISCLOSURE OF THE INVENTION

### Problems to be Solved by the Invention

However, in the patent document 1, although a method for obtaining an image via a communication network is described, data management after the obtaining of the image is not disclosed nor suggested. Accordingly, in a case where a display device has a function to periodically obtain data as an electronic mail reception function, there is a possibility that the vacant capacity (=recordable capacity) decreases because of an electronic mail and its attached data and a capacity shortage occurs.

An electronic photo frame includes a recording medium such as a flash memory or the like, for example. Compared with magnetic recording mediums such as a HDD (Hard Disk Drive) and the like, a flash memory is excellent in terms of cost but has a disadvantage that the capacity for recording data is relatively small. Accordingly, the management of the recordable capacity becomes important; however, there is a problem that the capacity management by manually deleting a file makes the user feel cumbersome.

Besides, according to the electronic photo frame in the patent document 2, even a user who does not have a personal computer or is not accustomed to using a personal computer, the user can enjoy a taken image easily and quickly.

However, as for the electronic photo frame disclosed in the patent document 2, it is necessary to perform registration and selection of an image to be displayed by directly operating the electronic photo frame. As described above, to change a display image, the user who performs the changeover needs to be situated in the vicinity of the electronic photo frame.

Accordingly, for example, if the user wants to quickly display a photo, which the user takes outside the user's home, on the user's home electronic photo frame, the user who takes the photo needs to send the image to the other user who is in the vicinity of the electronic photo frame and ask the other user to perform a display changeover with voice communication or the like.

Besides, according to the electronic photo frame in the patent document 2, there is an advantage that it is possible to easily display image data taken with a digital camera or the like on the photo frame; however, it is impossible to send an electronic mail to and make a phone call for a person in the displayed image.

The present invention has been made to deal with the above problems, and it is an object of the present invention to provide a display device that is a display device having a function to obtain data, especially, a function to obtain data with an electronic mail and is able to prevent a recordable capacity, without requiring a user's operation, from decreasing because of the obtaining of data and making it impossible to record the data as a result of this.

Besides, it is another object of the present invention to provide a display device that even in a case where the user is not situated in the vicinity of the display device, is able to display a taken image easily and quickly, easily send an electronic mail to or make a phone call for a person on the displayed image.

### Means for Solving the Problem

To achieve the objects, a display device according to the present invention having: a display portion that displays an image; a recording portion that records data; a communication portion that connects with a communication network to perform communication; and a mail reception portion that uses the communication portion to receive an electronic mail from the communication network and record the electronic mail into the recording portion; the display device includes: a condition determination portion that determines whether or not an electronic mail received by the mail reception portion meets a predetermined condition; and a data deletion portion that deletes attached data contained in an electronic mail which the condition determination portion determines does not meet the condition.

Besides, to achieve the objects, the display device according to the present invention includes a condition registration portion that accepts a sender mail address of the electronic mail and records the accepted sender mail address into the recording portion as a reception permission address; wherein the condition determination portion determines whether or not the sender mail address of the electronic mail received by the mail reception portion matches part or all of the reception permission address recorded in the recording portion; and considers that the electronic mail meets the condition in a case where both addresses match each other.

Besides, to achieve the objects, in the display device according to the present invention, the condition determination portion determines whether or not the electronic mail received by the mail reception portion is an electronic mail from a predetermined person; and in a case where the condition determination portion determines that the received electronic mail is not an electronic mail from the predetermined person, the data deletion portion deletes the attached data attached to the received electronic mail from the recording portion.

Besides, to achieve the objects, in the display device according to the present invention, the condition determination portion determines whether or not the electronic mail received by the mail reception portion is an electronic mail from a predetermined person; and in a case where the condition determination portion determines that the received electronic mail is an electronic mail from the predetermined person, the data deletion portion deletes the attached data attached to the received electronic mail from the recording portion.

Besides, to achieve the objects, the display device according to the present invention includes a reproduction determination portion that determines whether or not the attached data contained in the electronic mail received by the mail reception portion are reproducible; wherein the data deletion portion deletes the attached data, which the reproduction determination portion determines is not reproducible, from the recording portion.

Besides, to achieve the objects, a display device according to the present invention having: a display portion that displays an image; a communication portion that connects with a communication network to perform communication; a sending and reception portion that uses the communication portion to send and receive an electronic mail; the display device includes: a mail analysis portion that analyzes an electronic mail received by the sending and reception portion and determines whether or not image data that has a predetermined form or a size within a predetermined range is added to the electronic mail; and an image process portion that in a case where it is determined by the mail analysis portion that the image data is added to the electronic mail, controls the display portion to display the image data.

Besides, to achieve the objects, the display device according to the present invention includes a resending request portion that in a case where it is determined by the mail analysis portion that the image data is added to the electronic mail received by the sending and reception portion and the image data is not image data that has the predetermined form or a size within the predetermined range, controls the sending and reception portion to send a notification mail, which indicates a display impossibility of the image data or indicates a resending request for the image data, to a sender of the electronic mail.

Besides, to achieve the objects, the display device according to the present invention includes a recording portion that records image data; wherein in a case where image data which has the predetermined form or a size within the predetermined range is added to the electronic mail received by the sending and reception portion, the mail analysis portion records the image data as a temporary record image into the recording portion, gives an instruction for displaying the temporary record image to the image process portion; in a case where the temporary record image is successfully displayed, the mail analysis portion deletes a temporary record image whose record date is older than the temporary record image from the recording portion.

Besides, to achieve the objects, the display device according to the present invention includes: a connection portion that connects with a electronic device to perform an input of image data; and an image analysis portion that in a case where the connection portion detects an input of image data from the electronic device, analyzes the input image data; determines whether or not the image data has the predetermined form or a size within the predetermined range; and, in a case where the determination is true, controls the display portion to display the image data.

Besides, to achieve the objects, a display device according to the present invention includes: a display portion that is capable of displaying a person's image; a detection portion that detects whether or not an object touches the display portion; and a control portion that controls the display portion to display information regarding a person displayed at a position where the detection portion detects a touch.

Besides, to achieve the objects, a display device according to the present invention includes: a communication portion; and a control portion that controls the communication portion to make a phone call for the person displayed at the position where the detection portion detects the touch.

Besides, to achieve the objects, the display device according to the present invention includes: a communication portion; and a control portion that controls the communication portion to send an electronic mail to the person displayed at the position where the detection portion detects the touch.

Besides, to achieve the objects, the display device according to the present invention includes: a communication portion; and a control portion that controls the communication portion to display a preparation screen of an electronic mail sent to the person displayed at the position where the detection portion detects the touch.

### ADVANTAGES OF THE INVENTION

According to the above structure, the display device according to the present invention includes: the display portion that includes a liquid crystal panel and the like; the communication portion that is able to connect with a wide-area communication network such as an internet and the like; and the mail reception portion that uses the communication portion to receive an electronic mail from a mail server. Besides, the display device includes the condition determination portion that determines whether or not an electronic mail received by the mail reception portion meets the predetermined condition. Further, the display device includes the data deletion portion that deletes attached data contained in an electronic mail which the condition determination portion determines does not meet the condition. Because of this, a user sets the condition in advance, so that it is possible to delete predetermined attached data without requiring a user's operation. Accordingly, it is possible to reduce a burden on the user regarding the data management, and the convenience improves. Besides, it is possible to avoid problems that the recording portion becomes short of a recordable capacity and it becomes impossible to perform reception of an electronic mail and the like.

Besides, according to the above structure, the display device according to the present invention includes the condition registration portion that accepts, from the user, an address input of an electronic mail whose attached data is saved. The condition registration portion accepts the sender mail address of an electronic mail which the user wants to save; and records the accepted sender mail address into the recording portion as a reception permission address. If an electronic mail is received by the mail reception portion, the condition determination portion determines whether or not the sender mail address of the electronic mail matches part or all of the reception permission address; considers that the electronic mail meets the above predetermined condition in a case where both addresses match each other and saves the attached data. In a case where both addresses do not match each other, the data deletion portion deletes the attached data. Because of this, the user can easily set the condition of the electronic mail whose attached data is saved by using the sender mail address.

Besides, according to the above structure, if an electronic mail from the predetermined person is received, attached data of the electronic mail is automatically deleted. Because of this, it is possible to delete the predetermined attached data without requiring a user's operation. Accordingly, it is possible to reduce a burden on the user regarding the data management, and the convenience improves. Besides, it is possible to avoid the problems that the recording portion becomes short of a recordable capacity and it becomes impossible to perform reception of an electronic mail and the like.

Besides, according to the above structure, if an electronic mail from a person other than the predetermined person is received, attached data of the electronic mail is automatically deleted. Because of this, it is possible to delete the predetermined attached data without requiring the user's operation. Accordingly, it is possible to reduce the burden on the user regarding the data management, and the convenience improves. Besides, it is possible to avoid the problems that the recording portion becomes short of a recordable capacity and it becomes impossible to perform reception of an electronic mail and the like.

Besides, according to the above structure, the display device according to the present invention includes the reproduction determination portion that determines whether or not data attached to a received electronic mail is reproducible. If attached data that is not reproducible is detected by the reproduction determination portion, the data deletion portion deletes the attached data in question. Accordingly, the user does not need to set the condition of attached data to be saved in advance. Besides, it is possible to avoid problems that the not-reproducible attached data is recorded into the recording portion; and a wasted recording region occurs as a result of this.

Besides, according to the above structure, the display device according to the present invention includes the display portion that displays an image; the communication portion that connects with a communication network such as an internet and the like to perform communication; and a sending and reception portion that uses the communication portion to send and receive an electronic mail. Besides, the display device includes the mail analysis portion that in a case where there is an attached image in a received electronic mail, determines whether or not the attached image has s predetermined form such as the BMP (Bitmap) form, the JPEG (Joint Photographic Experts Group) form, for example. Besides, the mail analysis portion determines whether or not the attached image has a data size in the predetermined range. As a result of the determination, in a case where the received image meets part or all of the conditions, the image process portion displays the attached image by using the display portion. As a result of this, the image displayed on the display portion such as a liquid crystal panel or the like is automatically changed. Because of this, by only attaching an image to an electronic mail and sending the electronic mail to the display device, the user can perform a recording operation and a display operation of the image easily and quickly. Accordingly, for example, in a case where the user wants to quickly display a photo taken outside the user's home on the user's home display device, it is not necessary to send the image to the other person situated in the vicinity of the display device and ask the other person to register the image, and the convenience improves.

Besides, according to the above structure, the display device according to the present invention includes the resending request portion that sends a notification mail which indicates a resending request for image data to the sender of a mail with an attached image. In a case where it is determined by the mail analysis portion that the attached image of the received mail does not have the predetermined form, or in a case where it is determined by the mail analysis portion that the data size of the attached image exceeds the predetermined range, by using the communication portion, the resending request portion sends the notification mail that indicates the resending request to the sender of the mail with the attached image. Because of this, the user who sends the mail with the attached image can know whether or not the sent image is normally displayed. For example, in a case where an image having an image form that is not displayable is erroneously sent, by resending an appropriate image following the resending request, it is possible to perform the image display more surely.

Besides, according to the above structure, the display device according to the present invention includes the recoding portion such as a flash memory or the like. And, in the case where the mail analysis portion determines that the attached image of the received mail has the predetermined image form and a data size in the predetermined range, the attached image is recorded into the recording portion as a temporary record image. Besides, an instruction for displaying the temporary record image recorded this time is given to the image process portion. If the temporary record image is successfully displayed, the temporary record image that is the image which has a recoding time older than the temporary record image recorded this time, that is, the temporary record image that has been displayed so far is deleted from the recording portion. Because of this, because it is possible to always record only the latest temporary record image and automatically delete the old temporary record image displayed before, it is possible to effectively use the limited recording capacity of the recording portion.

Besides, according to the above structure, the display device according to the present invention includes the connection portion that connects with an outside electronic device, for example, such as a mobile phone, a digital camera or the like to input data. The connection portion includes data input portions such as an IrDA (Infrared Data Association) port for performing infrared communication, a USB terminal in conformity with the USB (Universal Serial Bus) standard and the like. Besides, the display device includes the image analysis portion that detects an input of image data by these data input portions and analyzes the input image data. The image analysis portion determines whether or not the input image data has the predetermined image form. Besides, the image analysis portion determines whether or not the input image data has a data size in the predetermined range. As results of the above determinations, in a case where the received image meets part or all of the conditions, the image analysis portion performs a display process of the attached image by using the display portion. Accordingly, for example, by only sending an image taken with a mobile phone to the display device by means of infrared communication or the like, the user can change the display image to automatically display the sent image. As described above, because it is not necessary to perform the recording operation, the selection operation of the image to be displayed and the like, the convenience for the user improves.

Besides, according to the above structure, the user can display the information of the displayed person by only touching the image of the displayed person.

Besides, according to the above structure, the user can make a phone call for the displayed person by only touching the image of the displayed person.

Besides, according to the above structure, the user can send a mail to the displayed person by only touching the image of the displayed person.

Besides, according to the above structure, the user can display a mail preparation screen for the displayed person by only touching the image of the displayed person.

### BRIEF DESCRIPTION OF THE DRAWINGS

FIG. 1 is a functional block diagram showing a structure of a functional portion of a display device according to a first embodiment.

FIG. 2 is a block diagram showing an internal structure of a display device according to the present invention.

FIG. 3 is a front view showing an appearance of a display device according to the present invention.

FIG. 4 is a top view showing an appearance of a display device according to the present invention.

FIG. 5 is a rear view showing an appearance of a display device according to the present invention.

FIG. 6 is a flow chart showing a process flow of a deletion procedure of attached data according to the first embodiment.

FIG. 7 is a functional block diagram showing a structure of a functional portion of a display device according to a second embodiment.

FIG. 8 is a flow chart showing a process flow of a deletion procedure of attached data according to the second embodiment.

FIG. 9 is a functional block diagram showing a structure of a functional portion of a display device according to a third embodiment.

FIG. 10 is a flow chart showing a process flow of a deletion procedure of attached data according to the third embodiment.

FIG. 11 is a screen diagram showing a received-mail list screen according to the first embodiment.

FIG. 12 is a screen diagram showing a received-mail list screen according to the second embodiment.

FIG. 13 is a functional block diagram showing a structure of a functional portion of a display device according to a fourth embodiment.

FIG. 14 is a flow chart showing a process flow of a procedure at a mail reception time according to the fourth embodiment.

FIG. 15 is a flow chart showing a process flow of a procedure at a data input time according to the fourth embodiment.

FIG. 16 is a functional block diagram showing a structure of a functional portion of a display device according to a fifth embodiment.

FIG. 17 is a front view showing a display screen a display device according to the fifth embodiment.

FIG. 18 is a flow chart showing a process flow of a procedure after touch detection according to the fifth embodiment.

### LIST OF REFERENCE SYMBOLS

1 electronic photo frame (display device)
11 control portion
11a mail reception portion
11b condition determination portion
11c data deletion portion
11d condition registration portion
11e reproduction determination portion
11f capacity determination portion
11g mail sending and reception portion (sending and reception portion)
11h mail analysis portion
11i resending request portion
11j image process portion
11k image analysis portion
11l changeover acceptance portion
11m display change portion
11n notification portion
12 memory
13 operation portion
14 touch panel (display portion, detection portion)
15 communication I/F portion (communication portion)
16 communication control portion (communication portion)
19 data input/output portion (connection portion)
20 flash memory (recoding portion)

### BEST MODE FOR CARRYING OUT THE INVENTION

Hereinafter, the embodiments of the present invention are described with reference to the drawings. Incidentally, the embodiments described here are examples and the present invention is not limited to the embodiments described here.

### Embodiment 1

### 1-1. Internal Structure

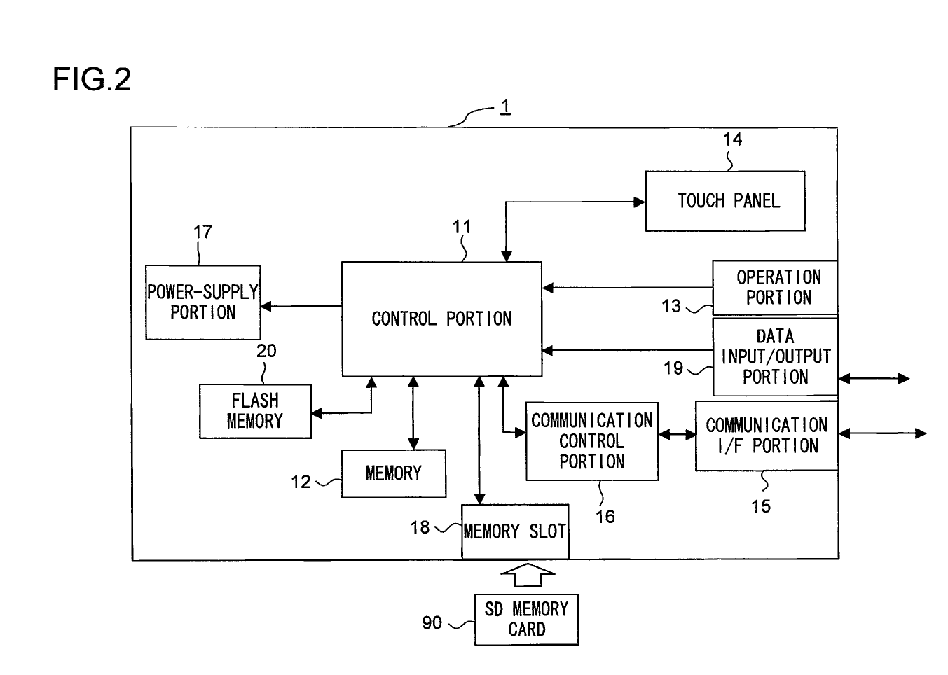

FIG. 2 is a block diagram showing an internal structure of an electronic photo frame 1 (=display device) according to a first embodiment of the present invention. The electronic photo frame 1 is so structured as to include at least: a control portion 11; a memory 12; an operation portion 13; a touch panel 14 (=display portion, detection portion); a communication I/F (Interface) portion 15 (=communication portion); a communication control portion 16 (=communication portion); a power-supply portion 17; a memory slot 18; a data input/output portion 19 (=connection portion); and a flash memory 20 (=recording portion). Besides, a memory card 90 that is an outside recording medium is removably connected to the memory slot 18.

The control portion 11 controls each device included by the electronic photo frame 1. In this way, the control portion 11 comprehensively controls a display process and the like of an image recoded in the flash memory 20 and of an image input from outside. The control portion 11 is composed of a plurality of microprocessors, for example. Besides, the control portion 11 is a central portion that performs data calculation, data processing and the like. Here, details of each functional portion (a mail reception portion 11a to a condition registration portion 11d) achieved by a predetermined program executed by the control portion 11 are described later.

The memory 12 is a medium that records temporarily various data held by the electronic photo frame 1 and is composed of a writable RAM (Random Access Memory) and the like, for example. The memory 12 has a role as a buffer memory for temporarily recording processed data when various processes are performed by the control portion 11 and a command and the like received from a user.

The operation portion 13 is used by a user to give various instructions such as an image changeover, an input of user information and the like to the electronic photo frame 1. The instruction input on the operation portion 13 is accepted by the control portion 11 and various types of control are performed based on the contents of the instruction. The operation portion 13 is composed of a plurality of buttons, switches and the like, for example.

By being touched by a user, the touch panel 14 accepts various instructions to the electronic photo frame 1. The touch panel 14 includes a display portion such as a LCD (Liquid Crystal Display) and the like that display an image recorded in a recording medium such as the flash memory 20 and the like. Besides, the touch panel 14 includes a touch detection portion (=detection portion) that detects a touch on a software keyboard, an icon and the like displayed on the LCD. The touch detection portion detects a touch by means of an electrode formed on a transparent surface film of a resistance film type, an electrostatic capacity type and the like.

The communication I/F portion 15 is a physical interface that connects the electronic photo frame 1 with a communication network. The communication I/F portion 15 is so structured as to include a LAN cable connector that connects with a wire LAN in conformity with the IEEE802.3 standard, a radio antenna that connects with a radio LAN in conformity with the IEEE802.11 standard and the like. Here, the communication I/F portion 15 may be so structured as to include an analog connection terminal that connects with a telephone communication network and an ISDN connection terminal that connects with an ISDN communication network.

The communication control portion 16 performs communication control to fulfill mutual communication with outside devices such as a mail server, an information delivery server and the like that are connected via the communication I/F portion 15. Because of this, it is possible to perform sending and reception of an electronic mail and obtain various information contents. Besides, in a case where the communication I/F portion 15 includes a radio antenna, the communication control portion 16 has a role in controlling the radio communication via a radio communication network.

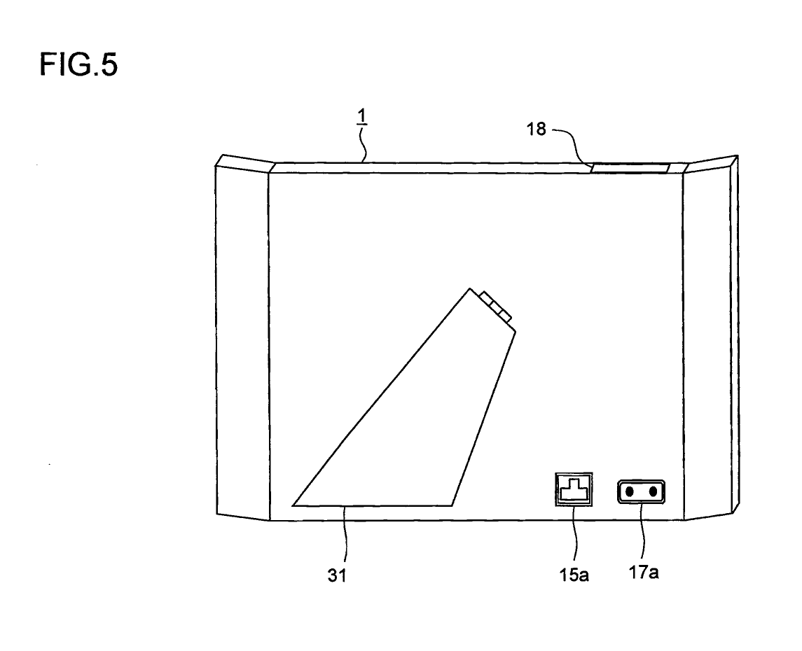

The power-supply portion 17 is supplied with electric power from an outside power supply (not shown) and gives a power-supply voltage to each portion of the electronic photo frame 1. The power-supply portion 17 includes a connection terminal (a power-supply cord connection terminal 17a shown in FIG. 5) with which a power-supply cord is connected to receive the electric-power supply from the outside power supply. This connection terminal is disposed on a rear surface side or the like of the electronic photo frame 1.

Or, the power-supply portion 17 may be so structured as, by using a dry cell or a secondary battery as the power supply, to allow the electronic photo frame 1 to be driven with separated from the outside power supply. As the secondary battery, it is possible to use a rechargeable alkaline battery, a lithium ion battery or the like.

The memory slot 18 is an interface that connects with an outside recoding medium such as a SD memory card 90 or the like to perform information transmission. A static image or a moving image taken with a digital camera, for example, is recorded in the SD memory card 90. The memory slot 18 copies these data into the flash memory 20 in response to an instruction from the control portion 11. In this way, it is possible to display an image input from outside on the touch panel 14.

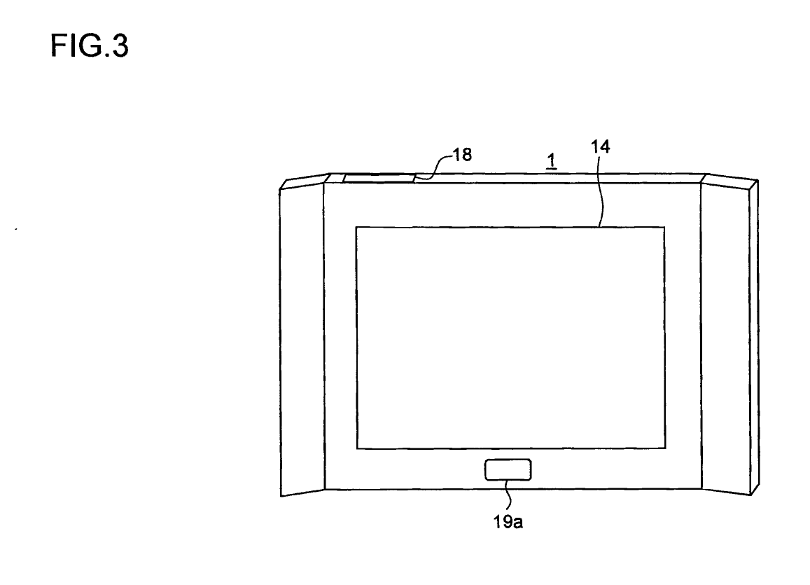

The data input/output portion 19 is an input interface that connects with an outside imaging device or a recording device over a wire or radio to perform an input of image data. The data input/output portion 19 is so structured as to include a socket for serial cable connection, an IrDA port 19a (FIG. 3) to perform infrared communication, or a USB connection terminal (not shown) and the like.

The flash memory 20 is a non-volatile recording medium that records various data held by the electronic photo frame 1. The flash memory 20 records electronic mail data received by the communication I/F portion 15, image data input by the data input/output portion 19 and the like. Besides, the flash memory 20 has a role in recording setting data for the electronic photo frame 1 and user data including personal data such as a mail address and the like.

### 1-2. Structure of Functional Portion

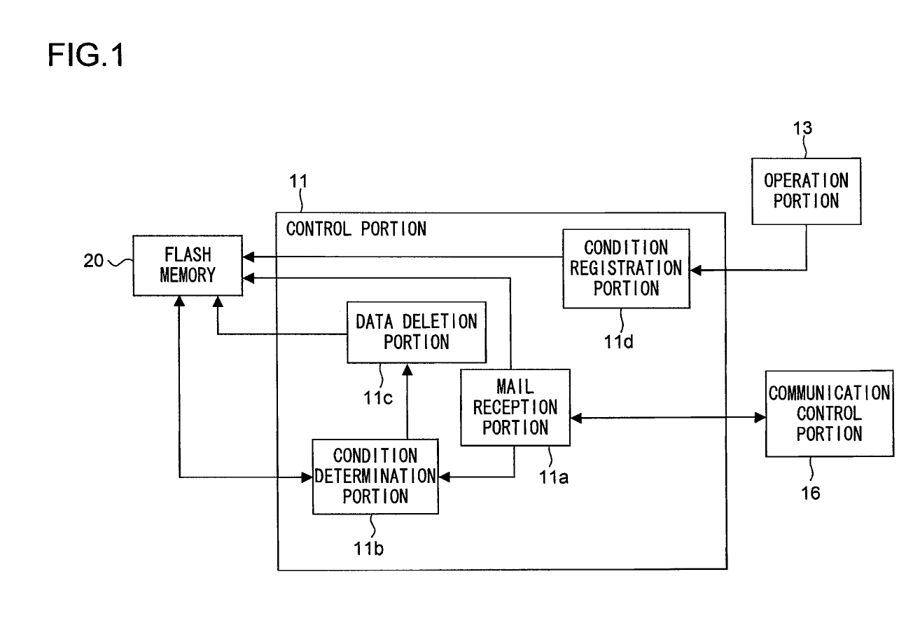

Here, a relationship among functional portions that perform an attached-data deletion procedure of the electronic photo frame 1 according to the first embodiment of the present invention is described by using a functional block diagram in FIG. 1.

As shown in FIG. 1, the attached-data deletion procedure according to the present invention is achieved by at least: a mail reception portion 11a, a condition determination portion 11b, a data deletion portion 11c, and a condition registration portion 11d of the control portion 11; an operation portion 13; a communication control portion 16; and a flash memory 20.

The mail reception portion 11a performs communication by using a mail server connected with an IP communication network, the communication I/F portion 15 and the communication control portion 16. Because of this, the mail reception portion 11a includes a mail client function to perform the reception of an electronic mail. The mail reception portion 11a performs the reception of an electronic mail by performing communication with a POP (Post Office Protocol) sever that provides a reception service of an electronic mail, for example. Or, by using a specific service provided by a communication company, for example, a mobile phone service, an L mode service and the like, the mail reception portion 11a may perform the reception of an electronic mail via a radioline for a mobile phone or a general telephone line.

The condition determination portion 11b performs a header analysis of a received electronic mail when the reception of the electronic mail is performed by the mail reception portion 11a. And, the condition determination portion 11b determines whether or not data is attached to the electronic mail and the mail address (hereinafter, called a “sender address”) that indicates the received-mail sender matches the mail address (hereinafter, called a “reception permission address”) that permits the reception of attached data. The determination result is given to the data deletion portion 11c described next.

In the above determination result, if the sender address and the reception permission address do not match each other, the data deletion portion 11c deletes the attached data of the mail in question. Further, the data deletion portion 11c adds flag information (=deletion performance information), which indicates that the deletion is performed, to the electronic mail whose attached data is deleted. As a result of this, a state is obtained, in which the electronic mail that contains data other than the attached data, for example, only the header data, the body data and the like is recoded in the flash memory 20. Here, the name of the attached data deleted is also contained in the flag information.

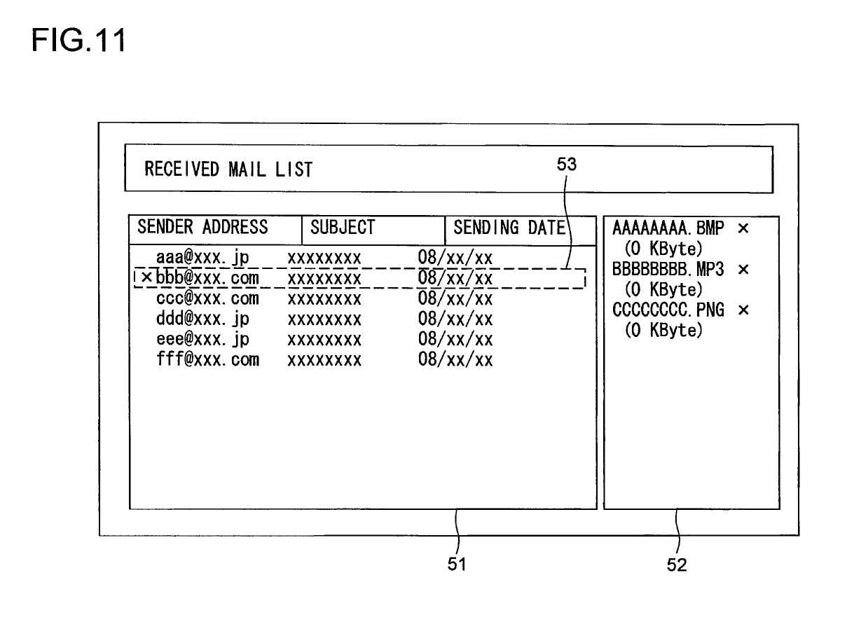

Here, the received mail to which the flag information is added is emphasized and displayed by multi-color display or adding an icon and the like to be distinguished from the usual received mails in the list screen of the received mails and the like. An example of this is described by using a screen diagram shown in FIG. 11.

FIG. 11 is an example of the received-mail list screen according to the present embodiment. The received-mail list screen is so structured as to include a mail-information display region 51 and an attached-image display region 52. Besides, the mail-information display region 51 includes a cursor 53 which the user uses to select a received mail from a plurality of received mails.

In the mail-information display region 51, in order from the left, a sender address, a subject and a sending date are displayed. Besides, in the attached-image display region 52, a list of the attached data of a received mail selected by the cursor 53 is displayed. In the example in FIG. 11, an “X” mark is added to the received mail whose sender address is “bbb @ xxx.com.” This means that the condition determination portion 11b determines that the received mail is a mail which does not match the reception permission address.

Because of this, the attached data of “bbb @ xxx.com”, that is, “AAAAAAAA.BMP” to “CCCCCCCC.PNG” displayed in the attached-data display region 52 are deleted by the data deletion portion 11c. As a result of this, on the right sides of the respective attached data, the “X” marks which indicate that the data are deleted are added. Besides, because of the deletion, the data sizes displayed under the respective data are also 0 KByte. In this way, the user can easily distinguish the usual received mail from the received mail whose attached data is deleted.

Here, because a usual reception process is applied to a received mail whose sender address and the reception permission address match each other, the data deletion portion 11c does not need to perform a process in particular.

The condition registration portion 11d accepts a setting of a reception permission address from the user. Specifically, the condition registration portion 11d displays a screen such as an input screen for a reception permission address or the like on the touch panel 14 and awaits a user's operation on the operation portion 13. And, the condition registration portion 11d records a sender mail address input through the operation portion 13 into the flash memory 20 and the like as the reception permission address.

Here, it is possible to set a plurality of reception permission addresses. Besides, the input sender address does not need to necessarily have the form of a mail address; and may have a form of a line of letters that indicate part of a mail address as “.com”, for example.

### 1-3. Appearance of Electronic Photo Frame

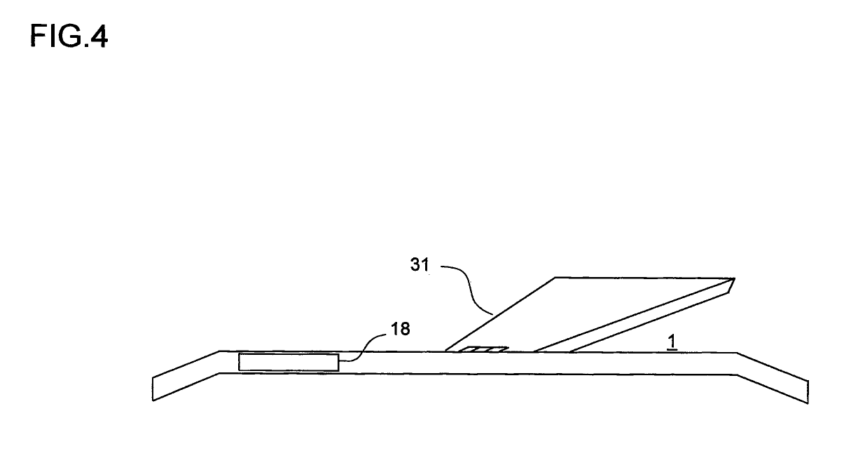

Here, an appearance of the electronic photo frame 1 according to the first embodiment of the preset invention is described by using a front view in FIG. 3, a top view in FIG. 4 and a rear view in FIG. 5.

FIG. 3 is a block diagram showing an example of each device portion provided on the front surface of the electronic photo frame 1. As shown in FIG. 3, the front surface of the electronic photo frame 1 is so structured as to include the touch panel 14 and the IrDA port 19a. Besides, FIG. 4 is a block diagram showing an example of each device portion provided on the top surface of the electronic photo frame 1. As shown in FIG. 4, the top surface of the electronic photo frame 1 includes the memory slot 18.

FIG. 5 is a block diagram showing an example of each device portion provided on the rear surface of the electronic photo frame 1. As shown in FIG. 5, the rear surface of the electronic photo frame 1 includes: a LAN connector 15a of the communication I/F portion 15; a power-supply connection terminal 17a of the power-supply portion 17; and a support leg portion 31. The LAN connector 15a is a connection terminal that connects the electronic photo frame 1 with a network by connecting a LAN cable. The power-supply connection terminal 17a is used to receive electric power from a commercial power supply by connecting a power-supply cord (not shown).

The support leg portion 31 is a member that is rotatably disposed on the electronic photo frame 1 and supports the electronic photo frame 1 from the rear. The support leg portion 31 is so structured as to suitably adjust, that is, to sharpen or ease the inclination of a surface of the electronic photo frame 1. Besides, the support leg portion 31 is able to rotate to change the electronic photo frame 1 up side down.

### 1-4. Attached-Data Deletion Procedure

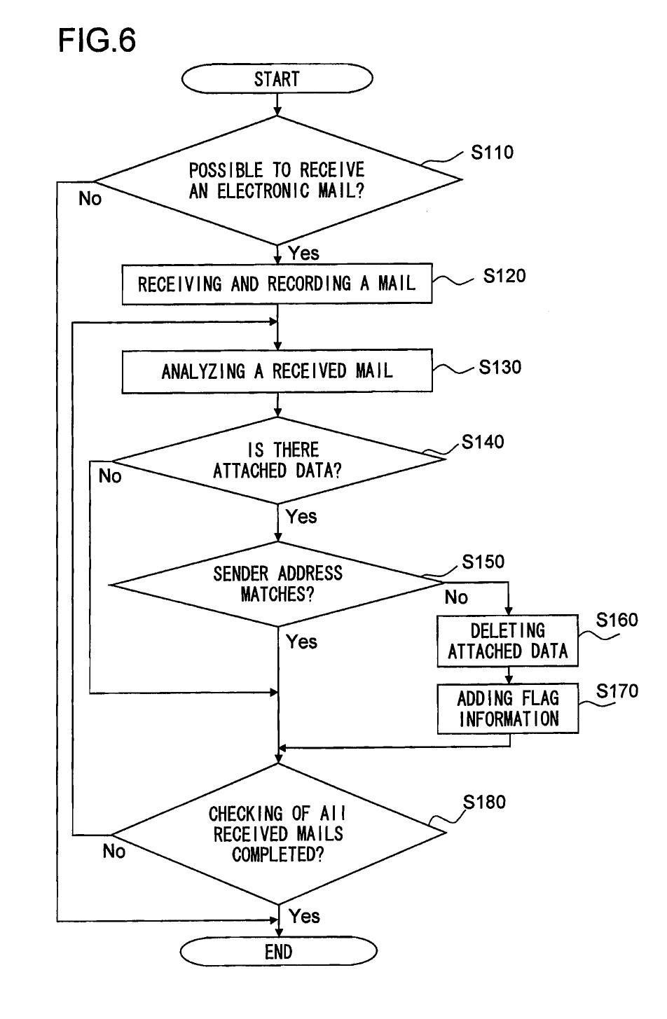

Here, the attached-data deletion procedure of the electronic photo frame 1 according to the first embodiment of the present invention is described by using a flow chart in FIG. 6.

FIG. 6 is a flow chart showing a process flow of the attached-data deletion procedure according to the present invention. This procedure is started when the power supply of the electronic photo frame 1 is started and the control portion 11 detects a reception instruction for an electronic mail. Here, the reception instruction for an electronic mail is issued, for example, when the user uses the operation portion 13 to perform a mail reception operation. Or, in a case where the reception process is so set as to start automatically and periodically, the reception instruction is issued when a predetermined reception timing comes.

After the present procedure is started, in a step S110, the mail reception portion 11a determines whether or not the communication control portion 16 is able to receive an electronic mail from an outside POP server (not shown). Here, the reception of an electronic mail is performed after the mail reception portion 11a sends a POP request to the POP server.

In a case where it is impossible to receive an electronic mail, for example, if there are no receivable electronic mails in the POP server, because there is no need to perform the deletion procedure, the present procedure is ended. In a case where it is possible to receive an electronic mail, in a step S120, the mail reception portion 11a performs a mail reception process and records an electronic mail received or a plurality of electronic mails received into the flash memory 20. Here, at this time, a notification sound that notifies the reception of an electronic mail may be output from a speaker (not shown).

Next, in a step S130, the condition determination portion 11b analyzes the electronic mail received by the mail reception portion 11a. Here, in a case where there are a plurality of received mails, the condition determination portion 11b arbitrarily selects an electronic mail that has not undergone the analysis process and analyzes it. And, based on the analysis result, in a step S140, the condition determination portion 11b determines whether or not data such as image data or the like is attached to the received mail.

If there is no attached data, because there is no need to perform the attached-data deletion procedure, the manipulation goes to a step S180. If there is attached data, in a step S150, the condition determination portion 11b determines whether or not the sender mail address of the electronic mail matches the reception permission address that is recorded in the flash memory 20 in advance by the condition registration portion 11d.

In a case where both addresses match each other, the manipulation goes to the step S180 described later. In a case where both addresses do not match each other, in a step S160, the data deletion portion 11c deletes the attached data of the electronic mail in question. Here, in a case where there are a plurality of attached data, the data deletion portion 11c deletes all the attached data. Next, in a step S170, the data deletion portion 11c adds the flag information, which indicates that the deletion is performed, to the electronic mail in question.

Next, in the step S180, the condition determination portion 11b determines whether or not a check procedure, that is, the processes in the step S130 and the following steps are applied to all the electronic mails received in the step S120. In a case where the check procedure is applied to all the mails, the present manipulation is ended. In a case where there is an electronic mail to which the check procedure is not applied, the manipulation goes to the step S130 again to continue the check procedure.

In the present embodiment described above, it is possible to delete the attached data of an electronic mail received by the mail reception portion 11a without requiring the user's operation. Besides, in the deletion, an electronic mail sent from the reception permission address is not a deletion target. Because of this, without requiring the user's operation, it is possible to secure a vacant capacity of the flash memory 20 and avoid occurrence of a capacity shortage.

### Embodiment 2

### 2-1. Internal Structure

Because the internal structure is the same as the first embodiment, description is skipped here.

### 2-2. Structure of Functional Portion

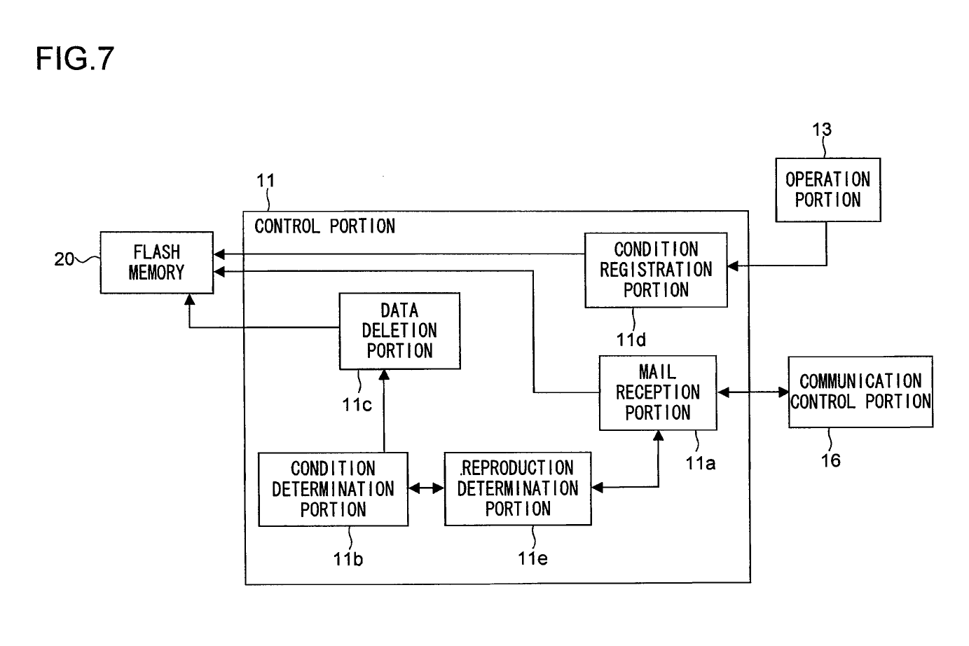

Here, a relationship among the functional portions that perform the attached-data deletion procedure of the electronic photo frame 1 according to the second embodiment of the present invention is described by using a functional block diagram in FIG. 7.

The control portion 11 in the second embodiment includes a reproduction determination portion 11e besides the mail reception portion 11a to the condition registration portion 11d in the first embodiment. Besides, the functions of the condition determination portion 11b and the data deletion portion 11c are partially different from the first embodiment.

The reproduction determination portion 11e determines whether or not attached data of a received mail is reproducible data. As a specific determination method, the reproduction determination portion 11e obtains the type of the file extension contained in the file name or the like of the attached data. And, the reproduction determination portion 11e determines whether or not the obtained file extension matches a predetermined reproducible file extension. The determination result is given to the condition determination portion 11b.

For example, it is supposed that JPG, BMP, WAV, MP3 are set in advance as the reproducible file extensions. Because of this, if the file extension of the attached data is GIF, PNG, AAC, or the like, these attached data are regarded as being non-reproducible. Here, the type information of the reproducible file extension is recorded into the flash memory 20 and the like at a shipment time or the like from a factory. Or, the type information may be built in a control program executed by the control portion 11.

When an electronic mail is received by the mail reception portion 11a, the condition determination portion 11b in the second embodiment determines whether or not the attached data is reproducible by using the reproduction determination portion 11c. The data deletion portion 11c that receives the determination result deletes the attached data in question in a case where the determination result indicates that the attached data is not reproducible.

Further, the data deletion portion 11c adds the flag information (=deletion performance information), which indicates that the deletion is performed, to the electronic mail whose attached data is deleted. Here, at this time, in a case where the reproducible attached data and the non-reproducible attached data mingle in an electronic mail, the data deletion portion 11c deletes the non-reproducible attached data only. The reproducible attached data is recorded into the flash memory 20 as usual.

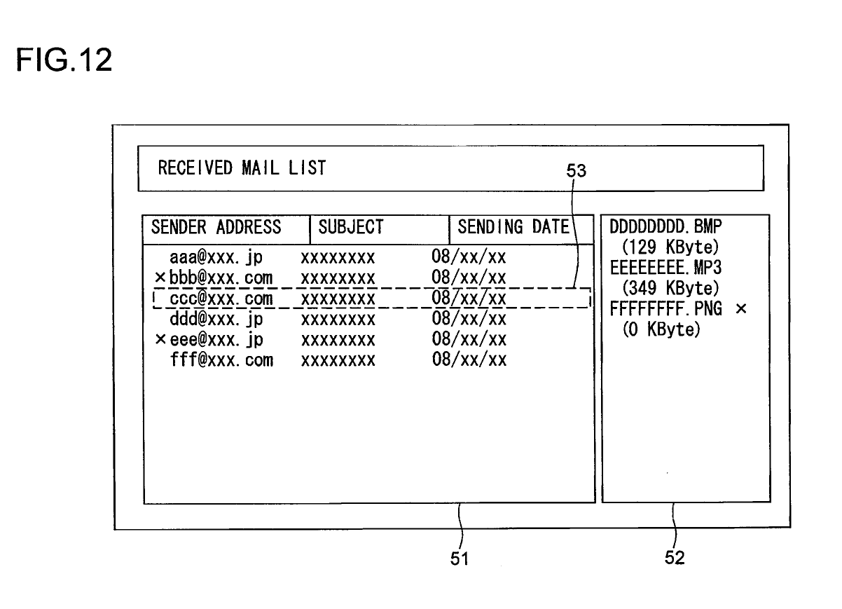

An example of the screen showing a received mail whose attached data is deleted is described by using a screen diagram in FIG. 12. FIG. 12 is an example of the received-mail list screen. In the example in FIG. 12, the mark “X” is added to “FFFFFFFF.PNG” of the attached data of a received mail whose sender address is “ccc @ xxx.com.” This means that the reproduction determination portion 11e determines that the attached data is not reproducible. Here, the reproduction determination portion 11e determines that the “DDDDDDDD.BMP” and the “EEEEEEEE.MP3” are reproducible attached data.

Because of this, the “FFFFFFFF.PNG” is deleted by the data deletion portion 11c from the flash memory 20; and the data size is 0 KByte. However, because the flag information is added to the mail in question at the deletion time, based on this, the name of the deleted data is displayed in the attached-data display region 52. Accordingly, the user can easily confirm the presence of the deleted attached data.

### 2-3. Appearance of Electronic Photo Frame

Because the appearance is the same as the first embodiment, description is skipped here.

### 2-4. Attached-Data Deletion Procedure

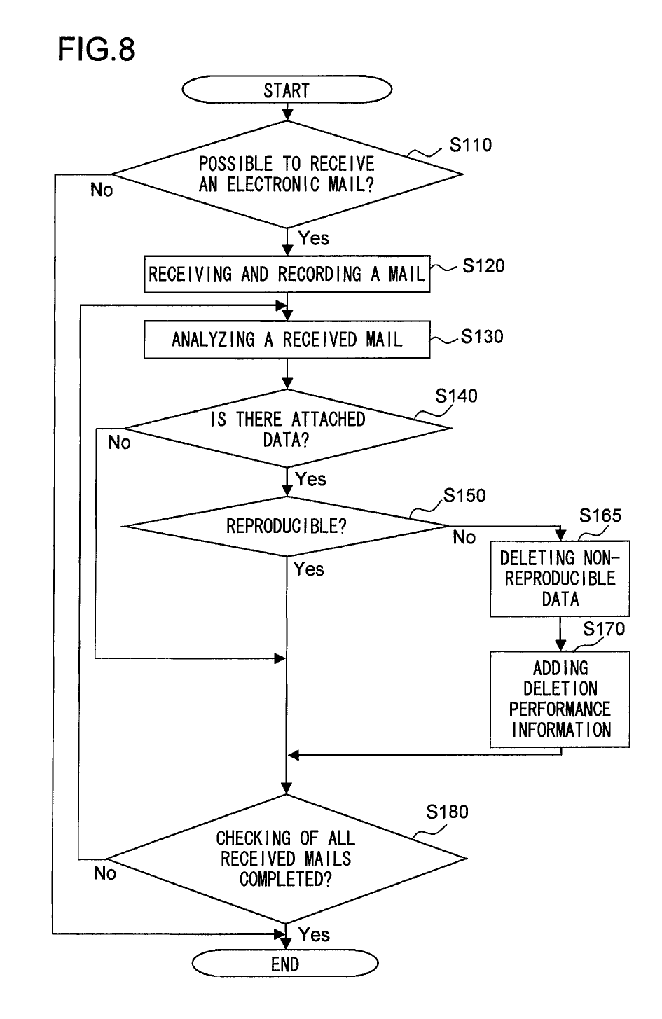

Here, the attached-data deletion procedure of the electronic photo frame 1 according to the second embodiment of the present invention is described by using a flow chart in FIG. 8. Here, the same processes as the first embodiment are indicated by the same step numbers and description of them is skipped.

After the present procedure is started, after the step S140 is executed, in a step S155, the condition determination portion 11b determines whether or not the attached data is reproducible by using the reproduction determination portion 11e. In a case where the attached data is reproducible, the manipulation goes to the step S180. In a case where the attached data is not reproducible, the manipulation goes to a step S165. Here, in a case where a plurality of data are attached to an electronic mail, if there is at least one of the attached data that is not reproducible, the manipulation goes to the step S165.

Next, in the step S165, the data deletion portion 11c deletes the attached data, which the reproduction determination portion 11e determines is not reproducible, from the flash memory 20. And, the data deletion portion 11c adds the flag information, which indicates that the deletion is performed, to the electronic mail to which the deleted data has been attached. Here, in a case where the reproducible attached data and the non-reproducible attached data mingle in an electronic mail, the data deletion portion 11c deletes the non-reproducible attached data only.

Because the processes in the step S170 and the following steps are the same as the first embodiment, description of them is skipped here.

According to the present embodiment described above, in a case where non-reproducible data is attached, it is possible to delete the data from the flash memory 20 without requiring the user's operation. Accordingly, it is possible to prevent the recording capacity of the flash memory 20 from being used by non-reproducible data that is less useful to the user; and as a result of this, it is also possible to avoid occurrence of a wasted recording region.

### Embodiment 3

### 3-1. Internal Structure

Because the internal structure is the same as the first embodiment, description is skipped here.

### 3-2. Structure of Functional Portion

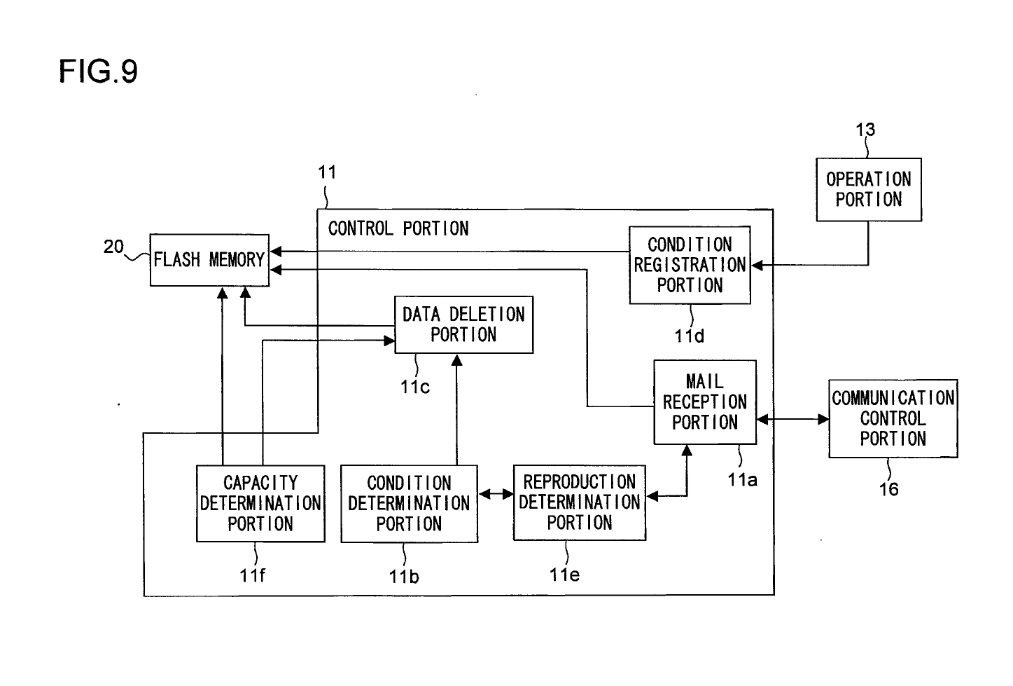

Here, a relationship among the functional portions that perform the attached-data deletion procedure of the electronic photo frame 1 according to the third embodiment of the present invention is described by using a functional block diagram in FIG. 9.

The control portion 11 in the present embodiment includes a capacity determination portion 11f besides the mail reception portion 11a to the reproduction determination portion 11e in the second embodiment. Besides, the functions of the condition determination portion 11b and the data deletion portion 11c are partially different from the first embodiment and the second embodiment.

The capacity determination portion 11f always monitors a vacant capacity of the flash memory 20. And, the capacity determination portion 11f determines whether or not the vacant capacity exceeds a predetermined value. Here, it is possible to suitably change and set the predetermined value in accordance with a use mode. For example, in a case where the vacant capacity exceeds 20% the total recoding capacity, it is determined that the vacant capacity exceeds the predetermined value. The determination result is given to the data deletion portion 11c and the like.

When an electronic mail is received by the mail reception portion 11a, the condition determination portion 11b in the present embodiment determines whether or not the sender address of the received mail matches the reception permission address; and the reproduction determination portion 11e determines whether or not the attached data is reproducible. In response to the determination results, only in a case where both addresses match each other and the attached data is reproducible in the determination results, the data deletion portion 11c saves the attached data and deletes the other attached data.

### 3-3. Appearance of Electronic Photo Frame

Because the appearance is the same as the first embodiment, description is skipped here.

### 3-4. Attached-Data Deletion Procedure

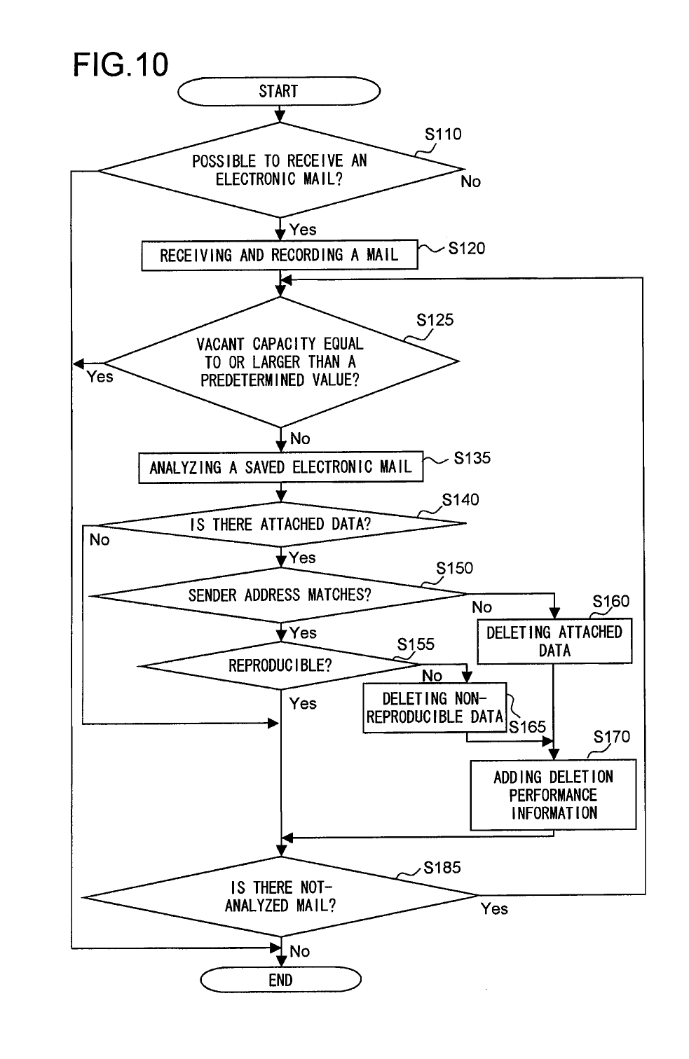

Here, the attached-data deletion procedure of the electronic photo frame 1 according to the third embodiment of the present invention is described by using a block diagram in FIG. 9 and a flow chart in FIG. 10. Here, the same processes as the first embodiment or the second embodiment are indicated by the same step numbers and description of them is skipped.

After the procedure is started, after the step S120 is executed, in a step S125, the capacity determination portion 11f determines whether or not the vacant capacity of the flash memory 20 exceeds the predetermined value. In a case where the vacant capacity exceeds the predetermined value, it is considered that there is no need to perform the attached-data deletion procedure, and accordingly the manipulation is ended.

In a case where the vacant capacity does not exceed the predetermined value, in a step S135, the condition determination portion 11b analyzes an electronic mail of the electronic mails that are some of the electronic mails saved in the flash memory 20 and have not undergone the analysis process. Here, the saved electronic mails include the electronic mails as well received in the step S120. In a case where there are a plurality of saved electronic mails, it is desirable to perform the check procedure in order from the saved electronic mail that has the oldest reception date, for example.

Based on the analysis result, in the step S140, the condition determination portion 11b determines whether or not data such as image data or the like is attached to the received mail. In a case where there are no attached data, the manipulation goes to a step S185. In a case where there is attached data, in the step S150, the condition determination portion 11b determines whether or not the sender address of the electronic mail matches the reception permission address that is recorded into the flash memory 20 by the condition registration portion 11d.

In a case where both addresses do not match each other, in the step S160, the data deletion portion 11c deletes the data attached to the electronic mail, then goes to a step S170. In a case where both addresses match each other, in the step S155, the condition determination portion 11b determines whether or not the attached data is reproducible by using the reproduction determination portion 11e. In a case where the attached data is reproducible, the manipulation goes to the step S185. In a case where the attached data is not reproducible, the manipulation goes to the step S165. Here, in a case where a plurality of data are attached to the electronic mail, if there is at least one of the attached data that is not reproducible, the manipulation goes to the step S165.

Next, in the step S165, the data deletion portion 11c deletes the attached data, which the reproduction determination portion 11e determines is not reproducible, from the flash memory 20, then goes to the step S170. If the information is added in the step S170, the manipulation goes to the step S185.

Next, in the step S185, the condition determination portion 11b determines whether or not the check procedure, that is, the processes in the step S130 and the following steps are applied to all the saved electronic mails recorded in the flash memory 20. In a case where the check procedure is applied to all the saved electronic mails, the present procedure is ended. In a case where there is a saved electronic mail to which the check procedure is not applied, the manipulation goes to the step S125 again to continue the check procedure.

According to the present embodiment described above, only in the case where the vacant capacity of the flash memory 20 becomes smaller than the predetermined amount, the deletion procedure is performed. Accordingly, because the deletion procedure is not performed in a case where there is a sufficient vacant capacity, it is possible to decrease the number of processes and reduce the process burden to the control portion 11. Because not only the received electronic mails but also all the saved electronic mails recorded are check targets, it is possible to start the deletion by giving priority to the electronic mail that has an old reception date, for example.

Besides, according to the present embodiment, the attached data of an electronic mail that is not the electronic mail sent from the reception permission address is deleted. Besides, even if the data is the attached data of the electronic mail sent from the reception permission address, the attached data is deleted in a case where the attached data is not reproducible. As described above, because the deletion of the attached data is performed in accordance with the plurality of conditions, it is possible to surely secure the vacant capacity of the flash memory 20.

### Embodiment 4

### 4-1. Internal Structure

Because the internal structure is the same as the first embodiment, description is skipped here.

### 4-2. Structure of Functional Portion

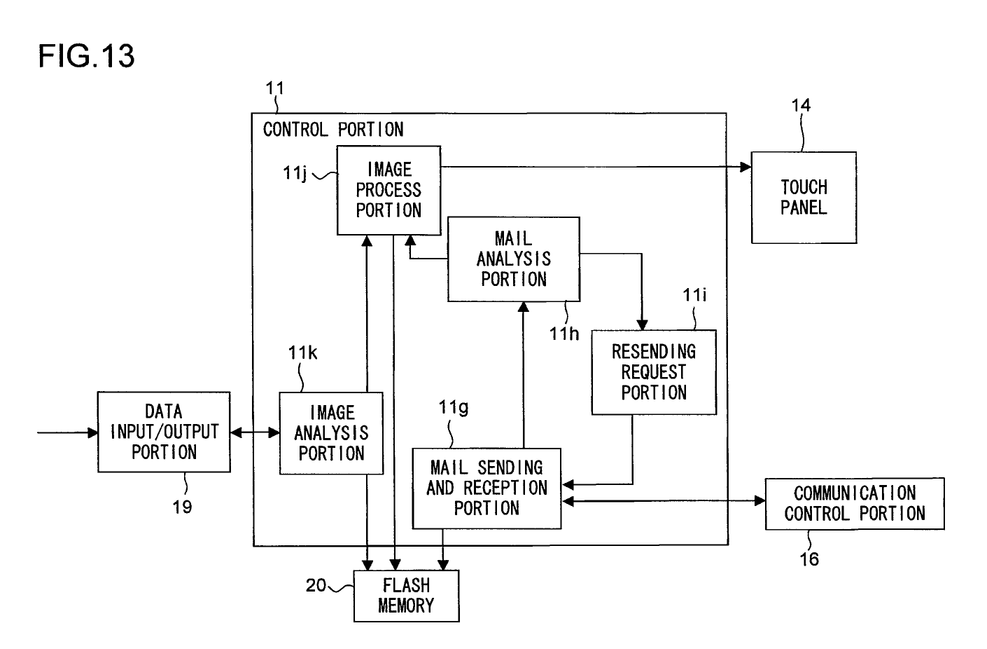

Here, a relationship among functional portions that perform a display changeover procedure of the electronic photo frame 1 according to the fourth embodiment of the present invention is described by using a functional block diagram in FIG. 13.

As shown in FIG. 13, the display changeover procedure according to the present invention is achieved by at least: a mail sending and reception portion 11g (=sending and reception portion), a mail analysis portion 11h, a resending request portion 11i, an image process portion 11j and an image analysis portion 11k of the control portion 11; the touch panel 14; the communication control portion 16; the data input/output portion 19; and the flash memory 20.

The mail sending and reception portion 11g performs communication by using the mail server connected with the IP communication network, the communication I/F portion 15 and the communication control portion 16. Because of this, the mail sending and reception portion 11g includes a mail-client function to perform sending and reception of an electronic mail. The mail sending and reception portion 11g performs the sending and reception of an electronic mail by connecting with a SMPT (Simple Mail Transfer Protocol) server that provides a sending and reception service of an electronic mail, a POP sever that provides a reception service of an electronic mail and the like, for example. Or, by using a specific service provided by a communication company, for example, a mobile phone service, an L mode service and the like, the mail sending and reception portion 11g may perform the sending and reception of an electronic mail via a radioline for a mobile phone or a general telephone line.

The mail sending and reception portion 11g in the present embodiment sends a reception request for an electronic mail to an outside mail server at a predetermined period, for example, at every 10 minutes. In case where there is a received mail to the electronic photo frame 1 in the mail server, the mail server sends the electronic mail to the electronic photo frame 1. As a result of this, the received electronic mail is recorded into the flash memory 20 and the like.

The mail analysis portion 11h analyzes the electronic mail received by the mail sending and reception portion 11g and determines whether or not image data is attached to the received mail. In a case where image data is attached, the mail analysis portion 11h obtains the image form and data size of the attached image and determines whether or not the obtained image form and data size match the predetermined conditions.

As the condition regarding the image form, it is determined whether or not the obtained image form matches BMP, JPEG or the like that are the image forms displayable on the touch panel 14. Confirmation of the image form is performed by obtaining the file name of the attached image and referring to the file extension (e.g., “.BMP” or the like) contained in the file name. Or, the confirmation may be performed by referring to the management information contained in a predetermined region (e.g., the header portion or the like) of the image data.

Besides, as the condition regarding the data size, range limits like “10 Kbytes or larger to 500 Kbytes or smaller” are set to determine whether or not the data size of the image data is in the predetermined range. Or, the number of pixels may be limited to determine whether or not the number of pixels of the image data is in the predetermined range, that is, whether or not the image data has the number of pixels that is equal to SXGA (Super-XGA, 1.3 Mpixcels, 1280×1024) or smaller.

In a case where the mail analysis portion 11h detects an attached image that matches the predetermined conditions described above as the examples, the mail analysis portion 11h records the image as a temporary record image into the flash memory 20 and gives an instruction for display of the recorded temporary record image to the image process portion 11j. And, in a case where the display is successfully performed, the old temporary record image recorded in the flash memory 20, that is, the temporary record image displayed before the temporary record image that is displayed this time is deleted from the flash memory 20.

On the other hand, in a case where the attached image does not match the predetermined condition, the mail analysis portion 11h gives a sending instruction for a resending request mail to the resending request portion 11i. The resending request portion 11i receives this and prepares a resending request mail that contains a display failure of the attached image and a request message for the resending of the image. And, by using the mail sending and reception portion 11g, the resending request portion 11i sends the prepared resending request mail to the sender address of the electronic mail to which the display failure image is attached.

As the resending request mail, for example, the resending request portion 11i sends an electronic mail that contains messages such as “the image display is failed” in the title section of the header data, “the attached image has an image form not displayable” in the body data and the like. Here, at this time, it is desirable to change the message contents based on the error type of the display failure.

In accordance with an instruction from each process portion, the image process portion 11j decodes the image data recoded in the flash memory 20 and gives an image signal obtained by the decoding to the display panel 14, thereby displaying the image.

The image analysis portion 11k monitors a state of the data input/output portion 19 and determines whether or not an image-data input is detected by the data input/output portion 19. In a case where an image-data input is detected, the image analysis portion 11k obtains the image form and data size of the input image. And, the image analysis portion 11k determines whether or not the obtained image form and data size match the predetermined conditions. Here, because the specific determination method is the same as the determination method that the mail analysis portion 11h applies to the attached image, description of the method is skipped.

In a case where the image analysis portion 11k detects an input image that matches the predetermined conditions, the image analysis portion 11k records the image as a temporary record image into the flash memory 20 and gives an instruction for display of the temporary record image to the image process portion 11j. And, in a case where the display is successfully performed, the old temporary record image recorded in the flash memory 20, that is, the temporary record image displayed before the temporary record image that is displayed this time is deleted from the flash memory 20.

### 4-3. Appearance of Electronic Photo Frame

Because the appearance is the same as the first embodiment, description is skipped here.

### 4-4. Procedure at Mail Reception Time

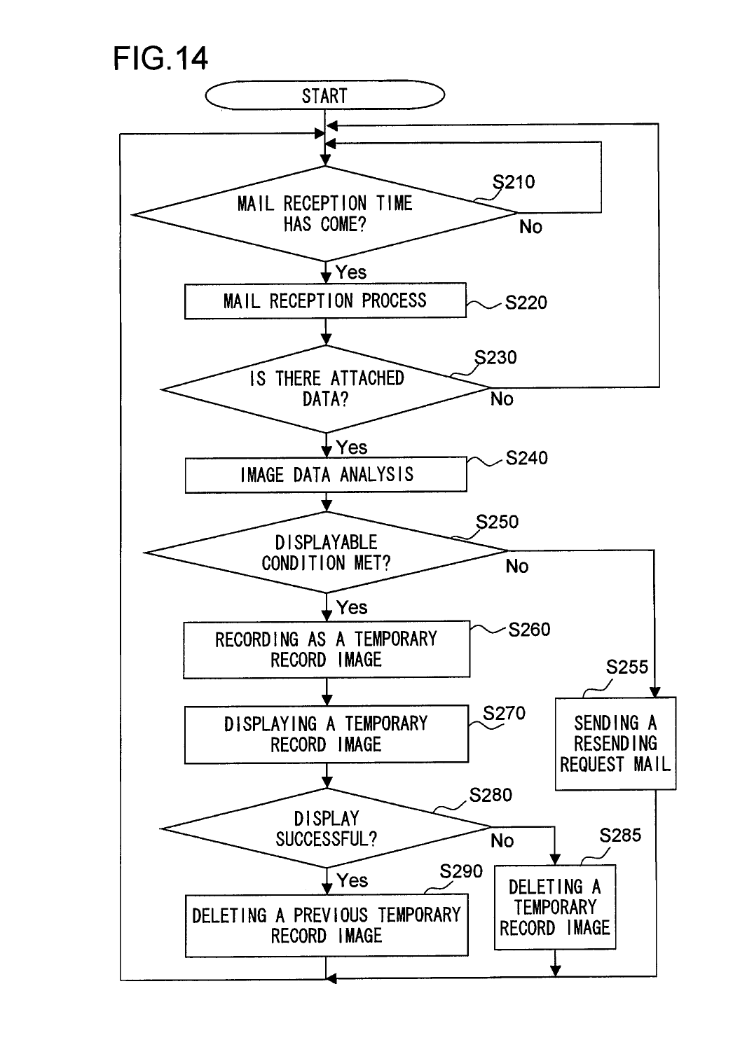

Here, a procedure at a mail reception time of the electronic photo frame 1 according to the fourth embodiment of the present invention is described by using a flow chart in FIG. 14.

FIG. 14 is a flow chart showing a process flow of a procedure at a mail reception time according to the fourth embodiment. It is possible to start the present procedure at an arbitrary timing with the power supply of the electronic photo frame 1 operating.

After the present procedure is started, in a step S210, the mail sending and reception portion 11g determines whether or not a mail reception time has come. Here, the mail reception time is able to be specified by a user's setting in advance. For example, by specifying 0:00, 1:00, 2:00, . . . as the reception times, it is possible to automatically gain access to the mail server at every hour and obtain a mail. Or, not by the time specification, it is also possible to obtain a mail every time a predetermined time elapses, for example, at every 10 minutes.

In a case where the mail reception time has not come, the manipulation goes to the step S210 again. In a case where the mail reception time has come, in a step S220, the mail sending and reception portion 11g sends a mail obtaining request to the outside mail server. As a result of this, in a case where there is a mail to be received in the mail server, the obtaining process of the mail data is performed.

Next, in a step S230, the mail analysis portion 11h determines whether or not the mail reception is successfully performed by the mail sending and reception portion 11g and image data is attached to the received mail. In a case where the mail reception fails because of reasons that image data is not attached or there is no mail to be received in the mail server or the like, the manipulation goes to the step S210 again.

In a case where image data is attached, in a step S240, the mail analysis portion 11h analyzes the image data. In this way, the mail analysis portion 11h obtains the image form and data size of the image data. Next, in a step S250, the mail analysis portion 11h determines whether or not the image data matches the predetermined displayable conditions, for example, whether or not the image data matches the predetermined image form, or has a data size in the predetermined range and the like.

In a case where the image data does not meet the displayable conditions, the manipulation goes to a step S255. In a case where the image data meets the displayable conditions, the manipulation goes to a step S260. Here, in a case where a plurality of images are attached to the electronic mail, the mail analysis portion 11h applies the analysis and determination to all the attached image data and if there is even an image that meets the displayable conditions, the manipulation goes to the step S260.

In a case where the manipulation goes to the step S255, the mail analysis portion 11h gives a sending instruction for a resending request mail to the resending request portion 11i. The resending request portion 11i receives this instruction; prepares an electronic mail that contains a display failure of the attached image and a request message for the resending of the image; and sends the prepared electronic mail to the sender address of the image-attached mail. After completion of the sending, the manipulation goes to the step S210 again.

In a case where the manipulation goes to the step S260, the mail analysis portion 11h records the attached image data as a temporary record image into the flash memory 20. Here, in a case where a plurality of image data are attached and there are a plurality of images that meet the displayable conditions, the mail analysis portion 11h selects the data of only one image in accordance with a predetermined condition and records the data as the temporary record image. For example, the image of the largest data size is given priority as the temporary record image. Or, the image form that is given priority to be displayed may be able to be set.

Next, in a step S270, the mail analysis portion 11h gives an instruction for display of the recorded temporary record image to the image process portion 11j. The image process portion 11j receives this instruction, reads the temporary record image from the flash memory 20, and decodes the temporary record image, thereby displaying the temporary record image on the touch panel 14. As a result of this, the image displayed so far is changed to the temporary record image.

Next, in a step S280, the mail analysis portion 11h determines whether or not the decoding and display of the temporary record image by the image process portion are normally ended. In a case where the display is successfully ended, in a step S290, the mail analysis portion 11h deletes the old temporary record image, that is, the temporary record image that does not have the latest record date; then, goes to the step S210. On the other hand, in a case where the display fails because of data breakage or the like, in a step S285, the mail analysis portion 11h deletes the temporary record image recorded in the step S260; then, goes to the step S255.

The process flow described above is ended when the electronic photo frame 1 stops its function because of reasons that, for example, an instruction for the stop of the electronic photo frame 1 is detected or the like. According to the above process flow, in the case where the electronic mail received by the mail sending and reception portion 11g has an attached image and the attached image meets the predetermined conditions, it is possible to automatically change the display image.

Because of this, by only sending an electronic mail with an attached image to the mail address of the electronic photo frame 1, the user can change the display image even from a going-out place. Accordingly, it is possible to eliminate the troubles to send the image to the other user situated in the vicinity of the electronic photo frame 1 and ask the other user for the registration work.

Besides, in a case where the attached image does not meet the predetermined conditions, the resending request portion 11i sends a resending request mail. Because of this, the user can know whether or not the sent image is normally displayed. Besides, of the temporary record images used for the display, only the latest temporary record image is recorded into the flash memory 20 and the old temporary record image is deleted, so that it is possible to effectively use the limited recoding capacity.

### 4-5. Procedure at Data Input Time

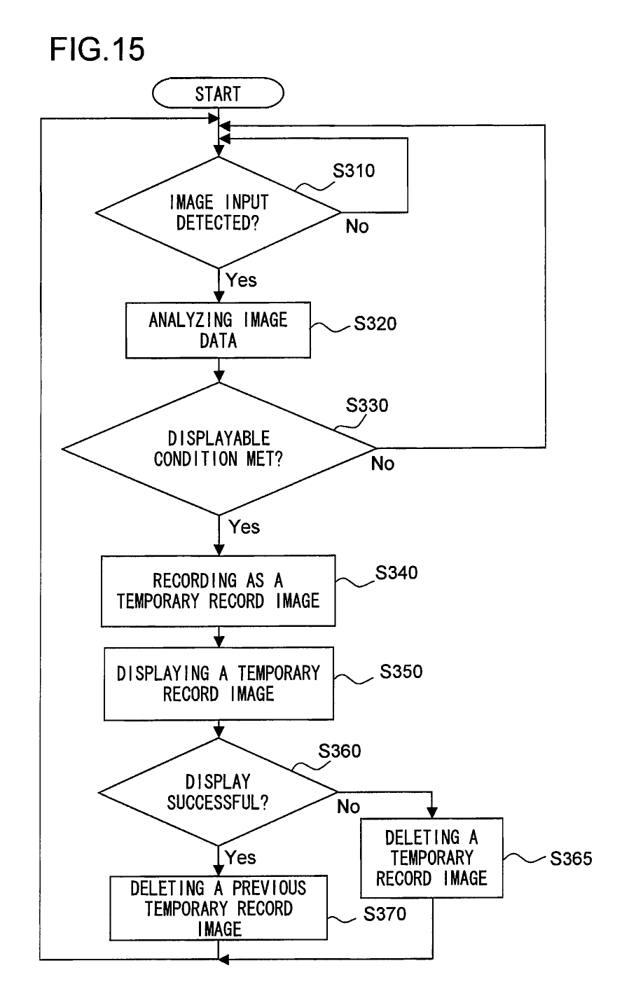

Here, a procedure at a data input time of the electronic photo frame 1 according to the fourth embodiment of the present invention is described by using a flow chart in FIG. 15.

FIG. 15 is a flow chart showing a process flow of a procedure at a data input time according to the present invention. It is possible to start the present procedure at an arbitrary timing with the power supply of the electronic photo frame 1 operating.

In a step S310, the image analysis portion 11k determines whether or not image data is input by the data input/output portion 19. In a case where an input of image data is not detected, the manipulation goes to the step S310 again.

In a case where an input of image data is detected, in a step S320, the image analysis portion 11k analyzes the image data. In this way, the image analysis portion 11k obtains the image form and data size of the image data. Next, in a step S330, the image analysis portion 11k determines whether or not the image data matches the predetermined conditions, for example, the predetermined image form, or has a data size in the predetermined range and the like.

In a case where the image data does not meet the conditions, the manipulation goes to the step S310. In a case where the image data meets the conditions, the manipulation goes to a step S340. Here, in a case where an input of a plurality images is detected, the image analysis portion 11k applies the analysis and determination to all the image data and if there is even an image that meets the conditions, it is desirable that the manipulation goes to the step S340.

In a case where the manipulation goes to the step S340, the image analysis portion 11k records the input image data as a temporary record image into the flash memory 20. Here, in a case where a plurality of image data are input and there are a plurality of images that meet the displayable conditions, the image analysis portion 11k selects the data of only one image in accordance with a predetermined condition and records the data as the temporary record image.

Next, in a step S350, the image analysis portion 11k gives an instruction for display of the recorded temporary record image to the image process portion 11j. The image process portion 11j receives this instruction, reads the temporary record image from the flash memory 20, and decodes the temporary record image, thereby displaying the temporary record image on the touch panel 14. As a result of this, the image displayed so far is changed to the temporary record image.

Next, in a step S360, the image analysis portion 11k determines whether or not the decoding and display of the temporary record image are normally ended. In a case where the display is successfully ended, in a step S370, the image analysis portion 11k deletes the old temporary record image, that is, the temporary record image that does not have the latest record date; then, goes to the step S310. On the other hand, in a case where the display fails because of data breakage or the like, in a step S365, the image analysis portion 11k deletes the temporary record image recorded in the step S340 from the flash memory 20; then, goes to the step S310.

The process flow described above is ended when the electronic photo frame 1 stops its function because of reasons that, for example, an instruction for the stop of the power supply of the electronic photo frame 1 is detected or the like. According to the above process flow, in the case where the image data is input from the outside device and the input image meets the predetermined conditions, it is possible to automatically change the display image. Because of this, by only sending an image taken with a mobile phone, for example, to the display device with infrared communication or the like, the user can automatically change the display image. Accordingly, it is possible to eliminate the troubles of various operations such as the recording operation, the selection operation and the like of the image to be displayed.

### Embodiment 5

### 5-1. Internal Structure

Because the internal structure is the same as the first embodiment, description is skipped here.

### 5-2. Structure of Functional Portion

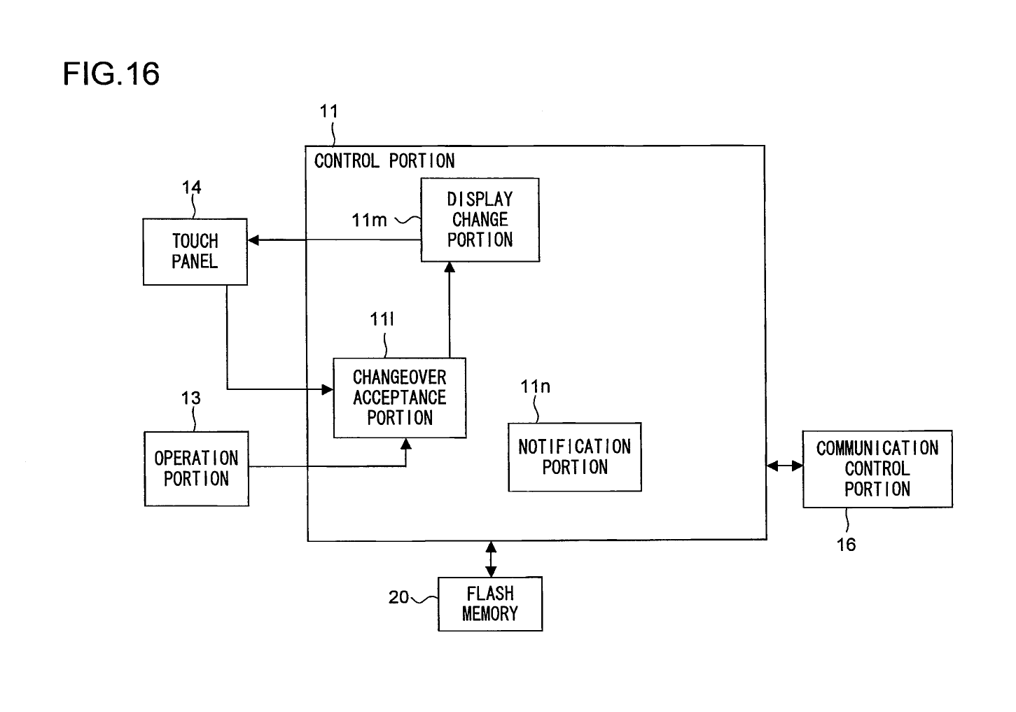

Here, a relationship among functional portions that perform an electronic-mail sending procedure of the electronic photo frame 1 according to the fifth embodiment of the present invention is described by using a functional block diagram in FIG. 16.

As shown in FIG. 16, the electronic-mail sending procedure according to the present invention is achieved by at least: a changeover acceptance portion 11l, a display change portion 11m, and a notification portion 11n of the control portion 11; the operation portion 13; the touch panel 14; the communication control portion 16; and the flash memory 20.

The changeover acceptance portion 11l accepts an operation from the operation portion 13 or the touch panel 14 and based on the operation, controls the display change portion 11m, the flash memory 20 and the like.

The display change portion 11m controls to or not to display an image on the touch panel 14.

### 5-3. Appearance of Electronic Photo Frame

Because the appearance is the same as the first embodiment, description is skipped here.

### 5-4. Procedure after Touch Detection

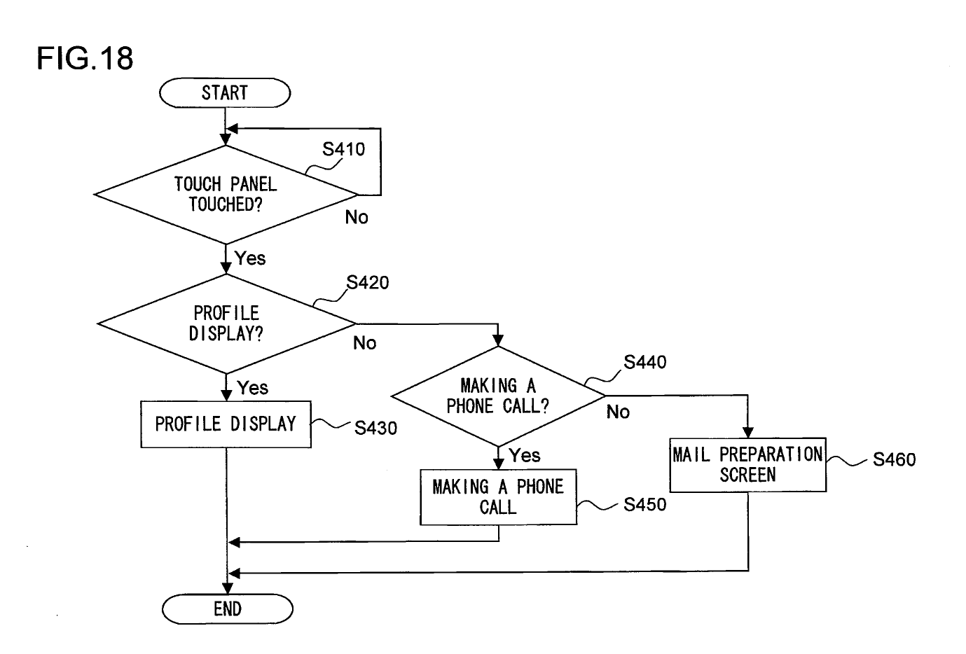

Here, a procedure after touch detection of the electronic photo frame 1 according to the fifth embodiment of the present invention is described by using a flow chart in FIG. 18.

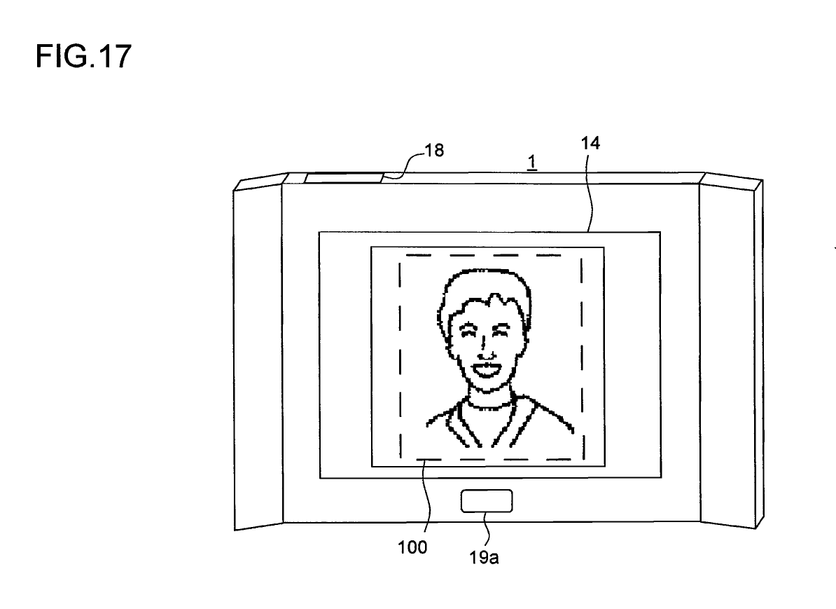

First, the user registers in advance operations that are performed by the electronic photo frame 1 when the user touches a person displayed on the touch panel 14. For example, in accordance with a specific position (a region 100 of the touch panel 14 enclosed by a dotted line in FIG. 17) of image data, the settings regarding operations (e.g., profile display, making a phone call, display of a mail preparation screen) to be performed are stored into the flash memory 20. Besides, profile data, phone number data, mail address data and the like which are to be displayed are also stored into the flash memory 20 in advance.

After completion of the above registration, it is possible to perform the procedure of the flow chart shown in FIG. 18. In a step S410, if the control portion 11 receives a signal, from the touch panel 14, indicating that a finger or the like touches a touch detection portion of the touch panel 14, the control portion 11 advances the manipulation to a step S420.

In the step S420, if the control portion 11 determines that the process corresponding to the person at a position where the touch detection portion detects the touch is the profile display, the control portion 11 advances the manipulation to a step S430; otherwise, advances the manipulation to a step S440. Here, the above determination is performed with reference to the set information that is stored in the flash memory 20 in advance.

Specifically, the control portion 11 checks whether or not the person corresponding to the position where the touch detection portion detects the touch is stored in the flash memory 20; if stored, in the step S420, the control portion 11 determines whether or not the process to be performed corresponding to the person is the profile display. Here, in a case where a touch on the region where the person is displayed is not detected, the control portion 11 does not go to the step S420 and the following steps.

In the step S430, the control portion 11 reads the profile corresponding to the person displayed at the position where the touch detection portion detect the touch in the step S410 from the flash memory 20 and makes the touch panel 14 display the profile.

In the step S440, if the control portion 11 determines that the process corresponding to the person at the position where the touch detection portion detects the touch is to make a phone call, the control portion 11 advances the manipulation to a step S450; otherwise, determines that the display of a mail preparation screen is the corresponding process and advances the manipulation to a step S460.

In the step S450, by controlling the communication control portion 16, the control portion 11 reads the phone number corresponding to the person displayed at the position where the touch detection portion detects the touch in the step S410 from the flash memory 20 and makes the communication control portion 16 dial the phone number.

In the step S460, by controlling the communication control portion 16, the control portion 11 reads the mail address corresponding to the person displayed at the position where the touch detection portion detects the touch in the step S410 from the flash memory 20 and makes the touch panel 14 display a mail preparation screen.

Here, in the step S460, the mail preparation screen is not displayed but instead, a predetermined-form letter may be automatically sent to the other person.

Here, in the above embodiment, a predetermined operation is performed when the touch detection portion of the touch panel 14 is touched with a finger; however, the predetermined operation may be performed by applying a member such as a touch pen or the like instead of a finger to the touch detection portion.

### Other Embodiments

The present invention is described above by using the preferred embodiments and examples; however, the present invention is not limited to the above embodiments and is able to be modified in various ways and put into practical use within the scope of the technical concept.

Accordingly, the present invention is also applicable in the following ways.

(A) In the above embodiments, the various functional portions relating to each of the above processes are achieved by executing the program on an operation processing device such as a microprocessor or the like; however, the various functional portions may be achieved by a plurality of circuits.

(B) Besides, in the above embodiments, the electronic photo frame 1 is described as an example of the display device that performs each process of the present invention; however, a display device that includes the mail sending and reception function is able to use the present invention. For example, the present invention may be used in a mobile phone, a PDA, a car navigation system, a television set and the like.

(C) Besides, in the above embodiments, the image file and the sound file and the like are described as the attached data that is deleted by the data deletion portion 11c; however, it is possible to apply the same deletion process to attached data other than these data. For example, it is possible to automatically delete document data, compressed data and the like with the same deletion process.

(D) Besides, in the above embodiments, the mail reception portion 11a records the attached data of the received mail into the flash memory 20; then, the data deletion portion 11c performs the deletion process; however, the deletion process may be performed on a stage before the data is recorded into the flash memory 20. For example, at the time the mail reception portion 11a starts the mail reception process and receives the header portion of an electronic mail, the data deletion portion 11c gives an interruption to the mail reception portion 11a. In this way, the mail reception portion 11a stops the mail reception process. In this state, the data deletion portion 11c analyzes the header portion that is already received and determines whether or not it is described in the header portion that there is attached data which is a deletion target. In a case where it is not described, the mail reception portion 11a resumes the reception process. In a case where it is described, an instruction is given to the mail reception portion 11a not to receive the attached data. As a result of this, for example, in a case where there is not a capacity in the flash memory 20 for recording the attached data at the mail reception time, a reception error does not occur, and it is possible to receive only the header portion and body of the electronic mail.

(E) Besides, in the above embodiments, the condition for the attached-data saving is that the sender address of a received mail and the reception permission address completely match each other; however, partial matching may be used as the condition. For example, it is supposed that, for example, a received permission address “c@ xxx.jp” is set as the reception permission address. In this case, it is considered that “abc@ xxx.jp” and “ccc@ xxx.jp” match partially each other. As a result of this, the attached data of the received mail of the above address is saved. As described above, by using the partial matching is used as the condition, it is possible to specify a plurality of received mails as the saving targets with the one set condition. Here, in the case where the partial matching is used, the set reception permission address may not necessarily have the form of a mail address (=a line of letters including @); for example, a line of letters such as “.com” or the like may be used.

(F) Besides, in the above embodiments, it is determined by using the type of a file extension whether or not the attached data is reproducible; however, it may be determined by using a method other than this. For example, the determination may be performed by using experimentally the attached data. Besides, information at a predetermined address is read from the head of the attached data and it may be checked whether or not the data type is described.

(G) Besides, in the above third embodiment, in the case where the vacant capacity of the flash memory 20 is smaller than the predetermined value, the check procedure is applied to all the received mails recorded in the flash memory 20; however, the check procedure may be applied to only part of the received mails. For example, the check procedure may be applied to only the electronic mail received most recently in the step S120. Or, the check procedure may be applied to only the electronic mail, of the electronic mails recoded in the flash memory 20, that the user has already read.

(H) Besides, in the above embodiments, the structure is employed, in which the attached file of an electronic mail from a person other than the predetermined person is automatically deleted; however, a structure may be employed, in which an attached file of an electronic mail from the predetermined person may be automatically deleted.

(I) Besides, in the above embodiments, in displaying a list of electronic mails, an electronic mail whose attached file is automatically deleted is displayed with the “X” mark added, so that the user is notified that the electronic mail is an electronic mail whose attached file is automatically deleted; however, a structure may be employed, in which in displaying the contents of an electronic mail, the user is notified that the electronic mail is an electronic mail whose attached file is automatically deleted.

(J) Besides, in the above fourth embodiment, as the displayable conditions of an attached image and an input image, the image form and the data size are set; however, conditions other than these conditions may be used to determine to or not to display. For example, the sender mail address, the mail reception time, the number of attached images, the attribute of an image and the like may be used. Accordingly, for example, it is possible not to display the attached image of a mail received from an address other than the predetermined mail address. As a result of this, an effect that an unnecessary image attached to a junk mail and the like is not displayed is obtained. Besides, for example, it is possible not to display an image that contains information, in the attribute information of the image, which indicates a viewer age limit. As a result of this, it is possible to obtain an effect that an inappropriate image is not displayed in the electronic photo frame 1 even if the electronic photo frame 1 is installed in a child room and the like.

1. A display device having:
a display portion that displays an image;
a recording portion that records data;
a communication portion that connects with a communication network to perform communication; and
a mail reception portion that uses the communication portion to receive an electronic mail from the communication network and record the electronic mail into the recording portion;
the display device comprising:
a condition determination portion that determines whether or not an electronic mail received by the mail reception portion meets a predetermined condition; and
a data deletion portion that deletes attached data contained in an electronic mail which the condition determination portion determines does not meet the condition.

2. The display device according to claim 1, further comprising a condition registration portion that accepts a sender mail address of the electronic mail and records the accepted sender mail address into the recording portion as a reception permission address;
wherein the condition determination portion determines whether or not the sender mail address of the electronic mail received by the mail reception portion matches part or all of the reception permission address recoded in the recording portion; and considers that the electronic mail meets the condition in a case where both addresses match each other.

3. The display device according to claim 1, wherein the condition determination portion determines whether or not the electronic mail received by the mail reception portion is an electronic mail from a predetermined person; and
in a case where the condition determination portion determines that the received electronic mail is not an electronic mail from the predetermined person, the data deletion portion deletes the attached data attached to the received electronic mail from the recording portion.

4. The display device according to claim 1, wherein the condition determination portion determines whether or not the electronic mail received by the mail reception portion is an electronic mail from a predetermined person; and
in a case where the condition determination portion determines that the received electronic mail is an electronic mail from the predetermined person, the data deletion portion deletes the attached data attached to the received electronic mail from the recording portion.

5. The display device according to claim 1, further comprising a reproduction determination portion that determines whether or not the attached data contained in the electronic mail received by the mail reception portion is reproducible;
wherein the data deletion portion deletes the attached data, which the reproduction determination portion determines is not reproducible, from the recording portion.

6. A display device having:
a display portion that displays an image;
a communication portion that connects with a communication network to perform communication;
a sending and reception portion that uses the communication portion to send and receive an electronic mail;
the display device comprising:
a mail analysis portion that analyzes an electronic mail received by the sending and reception portion and determines whether or not image data that has a predetermined form or a size within a predetermined range is added to the electronic mail;
and an image process portion that in a case where it is determined by the mail analysis portion that the image data is added to the electronic mail, controls the display portion to display the image data.

7. The display device according to claim 6, further comprising a resending request portion that in a case where it is determined by the mail analysis portion that the image data is added to the electronic mail received by the sending and reception portion and the image data is not image data that has the predetermined form or a size within the predetermined range, controls the sending and reception portion to send a notification mail, which indicates a display impossibility of the image data or indicates a resending request for the image data, to a sender of the electronic mail.

8. The display device according to claim 6, further comprising a recording portion that records image data;
wherein in a case where image data which has the predetermined form or a size within the predetermined range is added to the electronic mail received by the sending and reception portion, the mail analysis portion records the image data as a temporary record image into the recording portion, gives an instruction for displaying the temporary record image to the image process portion; in a case where the temporary record image is successfully displayed, the mail analysis portion deletes a temporary record image whose record date is older than the temporary record image from the recording portion.

9. The display device according to claim 6, further comprising:
a connection portion that connects with an electronic device to perform an input of image data; and
an image analysis portion that in a case where the connection portion detects an input of image data from the electronic device, analyzes the input image data; determines whether or not the image data has the predetermined form or a size within the predetermined range; and, in a case where the determination is true, controls the display portion to display the image data.

10. A display device comprising:
a display portion that is capable of displaying a person's image;
a detection portion that detects whether or not an object touches the display portion; and
a control portion that controls the display portion to display information regarding a person displayed at a position where the detection portion detects a touch.

11. The display device according to claim 10, further comprising:
a communication portion; and
a control portion that controls the communication portion to make a phone call for the person displayed at the position where the detection portion detects the touch.

12. The display device according to claim 10, further comprising:
a communication portion; and
a control portion that controls the communication portion to send an electronic mail to the person displayed at the position where the detection portion detects the touch.

13. The display device according to claim 10, further comprising:
a communication portion; and
a control portion that controls the communication portion to display a preparation screen of an electronic mail sent to the person displayed at the position where the detection portion detects the touch.
